(19) United States
(12) Patent Application Publication
(10) Pub. No.: US 2025/0096507 A1
(43) Pub. Date: Mar. 20, 2025

(54) RIGHT ANGLE TYPE CONNECTOR AND NOISE REDUCTION PART

(71) Applicant: Mitsubishi Electric Corporation, Tokyo (JP)

(72) Inventors: Ayumi SAKAI, Tokyo (JP); Yosuke WATANABE, Tokyo (JP); Kyota OTSUKA, Tokyo (JP)

(73) Assignee: Mitsubishi Electric Corporation, Tokyo (JP)

(21) Appl. No.: 18/970,434

(22) Filed: Dec. 5, 2024

Related U.S. Application Data
(63) Continuation of application No. PCT/JP2022/026132, filed on Jun. 30, 2022.

(51) Int. Cl. H01R 13/646

(52) U.S. Cl. CPC H01R 13/646

(57) ABSTRACT

A right angle type connector includes: a first signal terminal for differential signal, including a first portion and a second portion bent via a bent portion, and allocated for one differential signal; a second signal terminal for differential signal, including a first portion and a second portion bent via a bent portion, allocated for an other differential signal, and having a shorter entire length than an entire length of the first signal terminal; a grounding terminal including a first portion and a second portion bent via a bent portion, and allocated for grounding; and a first noise reduction part to increase a parasitic capacitance between the second signal terminal and the grounding terminal, the first noise reduction part being interposed between the first portion located on a bent portion side of the second signal terminal and the first portion located on a bent portion side of the grounding terminal.

### CROSS REFERENCE TO RELATED APPLICATION

This application is a Continuation of PCT International Application No. PCT/JP2022/026132, filed on Jun. 30, 2022, which is hereby expressly incorporated by reference into the present application.

### TECHNICAL FIELD

The present disclosure relates to a right-angle type connector that includes three terminals allocated as two differential signal terminals of a differential pair and a grounding terminal, and a noise reduction part that is attached to the right-angle type connector.

### BACKGROUND ART

An angle type connector that includes a plurality of contacts having a plurality of types of the lengths and that resolves a propagation delay difference between the contacts produced due to a difference between the lengths of the contacts is described in Patent Literature 1.

Patent Literature 1 describes a connector that includes three rows of a signal contact, a ground contact, and a signal contact in order from an inner side in a pin side housing, and has smaller permittivity of an insulation material on an outer side of a face at which the grounding contact is aligned and that serves as a boundary than permittivity of an insulation material on an inner side to seal the insulation material in the connector.

### CITATION LIST

### Patent Literature

Patent Literature 1: JP 11-329635 A

### SUMMARY OF INVENTION

### Technical Problem

Additionally, the connector described in Patent Literature 1 needs to be manufactured to seal insulation materials for each type in the pin side housing.

Furthermore, Patent Literature 1 does not describe at all allocating differential signals of a positive signal and a negative signal to terminals of the right angle type connector.

That is, in a case where terminals for the positive signal and the negative signal of the differential signals are allocated to terminals of the right angle type connector, there is a problem that a difference between the lengths of a terminal for the positive signal and a terminal for a negative signal deteriorates the degree of balance of the differential signals, a conversion amount from a differential mode signal to common mode noise becomes larger, and radiated noise from the terminals increases.

At the same time, there is also a problem that external common mode noise is converted into a differential mode signal, and noise immunity deteriorates.

Patent Literature 1 does not describe a right angle type connector that allocates terminals for a positive signal and a negative signal of differential signals, and does not describe the problem and the solution, either.

The present disclosure has been made in light of the above point, and an object of the present disclosure is to provide a right angle type connector that includes a first signal terminal for differential signal, allocated for one signal of the differential signal, a second signal terminal for differential signal, allocated for the other signal of the differential signals, and a grounding terminal allocated for grounding, and that can suppress deterioration of the degree of balance of the differential signals by a simple structure and suppress radiated noise from the terminals.

### Solution to Problem

A right angle type connector according to the present disclosure includes: a first signal terminal for differential signal, including a first portion and a second portion bent via a bent portion, and allocated for one signal of differential signals; a second signal terminal for differential signal, including a first portion and a second portion bent via a bent portion, and allocated for an other signal of the differential signals, the second signal terminal for differential signal having a shorter entire length than an entire length of the first signal terminal for differential signal; a grounding terminal including a first portion and a second portion bent via a bent portion, and allocated for grounding; and a first noise reduction part to increase a parasitic capacitance between the second signal terminal for differential signal and the grounding terminal, the first noise reduction part being interposed between the first portion located on a bent portion side of the second signal terminal for differential signal and the first portion located on a bent portion side of the grounding terminal.

### Advantageous Effects of Invention

According to the present disclosure, it is possible to suppress deterioration of the degree of balance of a positive signal and a negative signal of differential signals and suppress radiated noise from a terminal for the positive signal and a terminal for the negative signal in a right angle type connector that includes the terminals allocated for the differential signals.

### BRIEF DESCRIPTION OF DRAWINGS

FIG. 1 is a configuration diagram illustrating a right angle type connector according to Embodiment 1.

FIG. 2 is a configuration diagram illustrating a right angle type connector according to Embodiment 2.

FIG. 3 is a cross-sectional view illustrating a noise reduction part of a right angle type connector according to Embodiment 3.

### DESCRIPTION OF EMBODIMENTS

### Embodiment 1

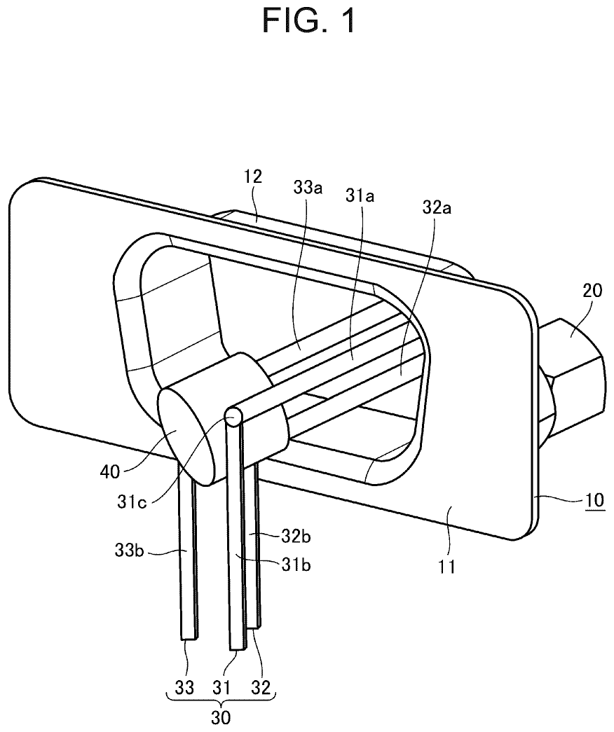

A right angle type connector according to Embodiment 1 will be described with reference to FIG. 1.

The right angle type connector according to Embodiment 1 includes a metal shield 10, a plurality of terminals 30, and a first noise reduction part 40.

The right angle type connector according to Embodiment 1 is, for example, a D-sub connector where a plurality of terminals are aligned in two rows of an upper row and a lower row on left and right sides. In this regard, the right angle type connector may be applied to D-sub connectors having three rows or four rows on upper and lower sides, RJ45 connectors, and USB connectors.

In short, as long as the plurality of terminals 30 include a first signal terminal 31 for differential signal, allocated for one signal of differential signals, a second signal terminal 32 for differential signal, allocated for the other signal of the differential signals, and a grounding terminal 33 allocated for grounding, Embodiment 1 is applicable to any types of right angle type connectors.

Although FIG. 1 illustrates only the first signal terminal 31 for differential signal, the second signal terminal 32 for differential signal, and the grounding terminal 33 as the plurality of terminals 30 to describe features of the right angle type connector according to Embodiment 1, the plurality of terminals 30 may include terminals for other signals.

The metal shield 10 includes a mounting plate 11 that has a D-shaped opening at the center, and a connector portion 12 that includes a fitting surface facing the opening of the mounting plate 11.

Holding portions of cables fit to the connector portion 12, and the plurality of terminals 30 are connected to the corresponding cables at the connector portion 12.

The back surface of the mounting plate 11 is in contact with the inner surface of a housing of an electronic device, and the mounting plate 11 is mounted on the housing of the electronic device by connector fixing screws 20 on both sides of a lateral direction illustrated in FIG. 1 to attach the metal shield 10 to the housing of the electronic device.

The connector portion 12 of the metal shield 10 protrudes outside the housing of the electronic device.

A substrate including a wiring layer formed thereon is housed in the housing of the electronic device.

The wiring layer is formed on one of the top surface, the back surface, and an inner layer surface of the substrate.

As for the signal terminals for the differential signals, there is a case where the terminal 31 and the terminal 32 adjacent to the grounding terminal 33 are allocated as the first signal terminal 31 for differential signal and the second signal terminal 32 for differential signal in terms of a relationship with the grounding terminal 33, arrangement of the cables, a relationship with the wiring layer of the substrate, and the like.

Each of the first signal terminal 31 for differential signal and the second signal terminal 32 for differential signal is a signal terminal for one of a positive signal and a negative signal of the differential signals.

For example, it is assumed that the first signal terminal 31 for differential signal is allocated for the positive signal, and the second signal terminal 32 for differential signal is allocated for the negative signal.

The first signal terminal 31 for differential signal includes a first portion 31a and a second portion 31b that is bent via a bent portion 31c.

The distal end of the first portion 31a is electrically connected with a corresponding lead connected to the connector portion 12.

The distal end of the first portion 31a is held by a non-conductive terminal holding member at the connector portion 12.

The first portion 31a linearly extends from the distal end, protrudes from the opening of the mounting plate 11 of the metal shield 10, and reaches the bent portion 31c.

The second portion 31b is bent at a right angle at the bent portion 31c, linearly extends from the bent portion 31c, and reaches the distal end.

The distal end of the second portion 31b penetrates a corresponding wiring layer formed on the surface of the substrate housed in the electronic device, and is electrically and mechanically connected to the corresponding wiring layer by soldering.

Note that, although 31a denotes the first portion and 31b denotes the second portion, 31a may denote the second portion and 31b may denote the first portion to the contrary.

Furthermore, although the bent portion 31c is a point at which the first portion 31a and the second portion 31b are bent at the right angle, the first portion 31a and the second portion 31b may be bent at the right angle at two points.

In a case where the first portion 31a and the second portion 31b are bent at the right angle at the two points, a portion between the two points is the bent portion 31c.

The second signal terminal 32 for differential signal includes a first portion 32a and a second portion 32b that is bent via a bent portion 32c.

The distal end of the first portion 32a is electrically connected with a corresponding lead connected to the connector portion 12.

The distal end of the first portion 32a is held by a non-conductive terminal holding member at the connector portion 12.

The first portion 32a linearly extends from the distal end, protrudes from the opening of the mounting plate 11 of the metal shield 10, and reaches the bent portion 32c.

The second portion 32b is bent at the right angle at the bent portion 32c, linearly extends from the bent portion 32c, and reaches the distal end.

The distal end of the second portion 32b penetrates a corresponding wiring layer formed on the surface of the substrate housed in the electronic device, and is electrically and mechanically connected to the corresponding wiring layer by soldering.

Note that, although 32a denotes the first portion and 32b denotes the second portion, 32a may denote the second portion and 32b may denote the first portion to the contrary.

Furthermore, although the bent portion 32c is a point at which the first portion 32a and the second portion 32b are bent at the right angle, the first portion 32a and the second portion 32b may be bent at the right angle at two points.

In a case where the first portion 32a and the second portion 32b are bent at the right angle at the two points, a portion between the two points is the bent portion 32c.

The grounding terminal 33 includes a first portion 33a and a second portion 33b that is bent via a bent portion 33c.

The distal end of the first portion 33a is connected to the connector portion 12 and is grounded.

The distal end of the first portion 33a is held by a non-conductive terminal holding member at the connector portion 12.

The first portion 33a linearly extends from the distal end, protrudes from the opening of the mounting plate 11 of the metal shield 10, and reaches the bent portion 33c.

The second portion 33b is bent at the right angle at the bent portion 33c, linearly extends from the bent portion 33c, and reaches the distal end.

The distal end of the second portion 33b penetrates a grounding layer formed on the surface of the substrate housed in the electronic device, and is electrically and mechanically connected to the grounding layer by soldering.

Note that, although 33a denotes the first portion and 33b denotes the second portion, 33a may denote the second portion and 33b may denote the first portion to the contrary.

Furthermore, although the bent portion 33c is a point at which the first portion 33a and the second portion 33b are bent at the right angle, the first portion 33a and the second portion 33b may be bent at the right angle at two points.

In a case where the first portion 33a and the second portion 33b may be bent at the right angle at the two points, a portion between the two points is the bent portion 33c.

The first signal terminal 31 for differential signal is disposed on the two rows, the second signal terminal 32 for differential signal is disposed in the row under the two rows, and the grounding terminal 33 is disposed on the two rows and adjacent to the first signal terminal 31 for differential signal.

That is, the first portion 31a of the first signal terminal 31 for differential signal, the first portion 32a of the second signal terminal 32 for differential signal, and the first portion 33a of the grounding terminal 33 are located at the vertexes of an equilateral triangular cross section of a plane parallel to the opening surface of the mounting plate 11. Note that there is also a case where the cross section is a triangle not the equilateral triangle.

Furthermore, the second portion 31b of the first signal terminal 31 for differential signal, the second portion 32b of the second signal terminal 32 for differential signal, and the second portion 33b of the grounding terminal 33 are located at the vertexes of the equilateral triangular cross section of the plane parallel to the plane including the first portion 31a of the first signal terminal 31 for differential signal and the first portion 33a of the grounding terminal 33. Note that there is also a case where the cross section is a triangle not the equilateral triangle.

Hence, in a case where the cross section is the equilateral triangle, a distance between the first portion 31a of the first signal terminal 31 for differential signal and the first portion 33a of the grounding terminal 33, and a distance between the first portion 32a of the second signal terminal 32 for differential signal and the first portion 33a of the grounding terminal 33 are the same.

Similarly, in a case where the cross section is the equilateral triangle, a distance between the second portion 31b of the first signal terminal 31 for differential signal and the second portion 33b of the grounding terminal 33, and a distance between the second portion 32b of the second signal terminal 32 for differential signal and the second portion 33b of the grounding terminal 33 are the same.

In short, the distance between the first signal terminal 31 for differential signal and the grounding terminal 33 and the distance between the second signal terminal 32 for differential signal and the grounding terminal 33 are made the same as much as possible to suppress deterioration of the degree of balance of the differential signals.

However, since the second signal terminal 32 for differential signal is allocated to the row under the first signal terminal 31 for differential signal, the first portion 32a of the second signal terminal 32 for differential signal is shorter than the first portion 31a of the first signal terminal 31 for differential signal at the portion that reaches the bent portion 32c.

Furthermore, the second portion 32b of the second signal terminal 32 for differential signal is shorter than the second portion 31b of the first signal terminal 31 for differential signal at the portion that reaches the bent portion 32c.

As a result, the entire length of the second signal terminal 32 for differential signal is shorter than the entire length of the first signal terminal 31 for differential signal.

Note that each of a portion of the first portion 32a of the second signal terminal 32 for differential signal that reaches the bent portion 32c and a portion of the first portion 31a of the first signal terminal 31 for differential signal that reaches the bent portion 31c, and a portion of the second portion 32b of the second signal terminal 32 for differential signal that reaches the bent portion 32c, and a portion of the second portion 31b of the first signal terminal 31 for differential signal that reaches the bent portion 31c is a portion at which the lengths of the two terminals are different, that is, a portion at which there is a difference between the lengths of the two terminals.

When one signal of the differential signals is caused to flow to the first signal terminal 31 for differential signal and the other signal of the differential signals is caused to flow to the second signal terminal 32 for differential signal in a state where the entire length of the second signal terminal 32 for differential signal is shorter than the entire length of the first signal terminal 31 for differential signal, the lengths of the first signal terminal 31 for differential signal and the second signal terminal 32 for differential signal are different, and therefore the degree of balance of the differential signals deteriorates particularly at the portion at which there is the difference between the lengths of the two terminals.

In other words, the parasitic capacitance between the second signal terminal 32 for differential signal and the grounding terminal 33 is smaller than the parasitic capacitance between the first signal terminal 31 for differential signal and the grounding terminal 33, and therefore the degree of balance of the differential signals deteriorates.

When the degree of balance of the differential signals deteriorates, a conversion amount from a differential mode signal to common mode noise becomes larger, and radiated noise from the first signal terminal 31 for differential signal and the second signal terminal 32 for differential signal increases. At the same time, external common mode noise is converted into a differential mode signal, and noise immunity deteriorates.

The right angle type connector according to Embodiment 1 includes the first noise reduction part 40 to suppress deterioration of the degree of balance of the differential signals due to a difference between the lengths of the first signal terminal 31 for differential signal and the second signal terminal 32 for differential signal, more particularly, deterioration of the degree of balance of the differential signals at a portion at which the lengths of the two terminals are different.

The first noise reduction part 40 is interposed between a part, near the bent portion 32c, of the first portion 32a of the second signal terminal 32 for differential signal and a part, near the bent portion 33c, of the first portion 33a of the grounding terminal 33, and increases a parasitic capacitance between the second signal terminal 32 for differential signal and the grounding terminal 33.

The first noise reduction part 40 is continuously interposed between a part, near the bent portion 32c, of the second portion 32b of the second signal terminal 32 for differential signal and a part, near the bent portion 33c, of the second portion 33b of the grounding terminal 33.

The first noise reduction part 40 functions to make the parasitic capacitance between the second signal terminal 32 for differential signal and the grounding terminal 33 the same as the parasitic capacitance between the first signal terminal 31 for differential signal and the grounding terminal 33.

The first noise reduction part 40 functions to make the parasitic capacitance between the second signal terminal 32 for differential signal and the grounding terminal 33 the same as the parasitic capacitance between the first signal terminal 31 for differential signal and the grounding terminal 33 particularly at a portion at which there is a difference between the lengths of the second signal terminal 32 for differential signal and the first signal terminal 31 for differential signal, so that deterioration of the degree of balance of the differential signals is suppressed.

As a result, it is possible to suppress an increase in radiated noise from the first signal terminal 31 for differential signal and the second signal terminal 32 for differential signal, and deterioration of noise immunity.

The first noise reduction part 40 is provided between the second signal terminal 32 for differential signal and the grounding terminal 33 at a portion at which there is the difference between the lengths of the second signal terminal 32 for differential signal and the first signal terminal 31 for differential signal, that is, at the bent portion 32c.

The first noise reduction part 40 is made of, for example, a dielectric that has higher permittivity than that of the air.

The first noise reduction part 40 makes the permittivity between the second signal terminal 32 for differential signal and the grounding terminal 33 different from, that is, higher than the permittivity between the first signal terminal 31 for differential signal and the grounding terminal 33.

Next, a specific configuration of the first noise reduction part 40 will be exemplified.

The first noise reduction part 40 is a material of a sponge shape that penetrates the second signal terminal 32 for differential signal, is fixed to the second signal terminal 32 for differential signal, and has higher permittivity than that of air.

By using the material of the sponge shape as the first noise reduction part 40, it is possible to make the material of the sponge shape penetrate the second signal terminal 32 for differential signal and the grounding terminal 33, and fix the material of the sponge shape to the positions of the bent portion 32c and the bent portion 33c after the first signal terminal 31 for differential signal, the second signal terminal 32 for differential signal, and the grounding terminal 33 are allocated in the right angle type connector.

Furthermore, the first noise reduction part 40 is a thermoplastic resin or a thermosetting resin that is fixed to the second signal terminal 32 for differential signal.

By using the thermoplastic resin or the thermosetting resin as the first noise reduction part 40, it is possible to interpose and fix the thermoplastic resin or the thermosetting resin between the positions of the bent portion 32c of the second signal terminal 32 for differential signal and the bent portion 33c of the grounding terminal 33 after the first signal terminal 31 for differential signal, the second signal terminal 32 for differential signal, and the grounding terminal 33 are allocated in the right angle type connector.

The first noise reduction part 40 is the dielectric, and the first noise reduction part 40 that is the dielectric is interposed between the bent portion 32c of the second signal terminal 32 for differential signal and the bent portion 33c of the grounding terminal 33 by a noise-reduction-part holding member such as the thermoplastic resin, the thermosetting resin, or a string, and is fixed to the bent portion 32c of the second signal terminal 32 for differential signal.

By fixing the first noise reduction part 40 to the bent portion 32c of the second signal terminal 32 for differential signal by the noise-reduction-part holding member, it is possible to fix the first noise reduction part 40 to the bent portion 32c of the second signal terminal 32 for differential signal after the first signal terminal 31 for differential signal, the second signal terminal 32 for differential signal, and the grounding terminal 33 are allocated in the right angle type connector.

In short, even in a case of any first noise reduction part 40, the first noise reduction part 40 can be attached to the right angle type connector according to Embodiment 1 after the right angle type connector to which the first noise reduction part 40 is not yet attached is finished and after the first signal terminal 31 for differential signal, the second signal terminal 32 for differential signal, and the grounding terminal 33 are allocated, and the first noise reduction part 40 can be mounted on a plurality of types of right angle type connectors using as standard products the right angle type connectors to which the first noise reduction part 40 is not yet attached, so that it is possible to reduce man-hours taken to finish the right angle type connector according to Embodiment 1, and reduce manufacturing cost.

As described above, the right angle type connector according to Embodiment 1 includes the first signal terminal 31 for differential signal, allocated for one signal of differential signals, the second signal terminal 32 for differential signal, allocated for the other signal of the differential signals, and the grounding terminal 33 allocated for grounding, and the first noise reduction part 40 that increases the parasitic capacitance between the second signal terminal 32 for differential signal and the grounding terminal 33 is provided at the first portion 32a located on the bent portion 32c side of the second signal terminal 32 for differential signal whose entire length is shorter than the entire length of the first signal terminal 31 for differential signal, so that it is possible to suppress deterioration of the degree of balance of the differential signals flowing in the first signal terminal 31 for differential signal and the second signal terminal 32 for differential signal.

As a result, it is possible to suppress an increase in radiated noise from the first signal terminal 31 for differential signal and the second signal terminal 32 for differential signal, and deterioration of noise immunity.

Furthermore, the first noise reduction part 40 can be mounted after the first signal terminal 31 for differential signal, the second signal terminal 32 for differential signal, and the grounding terminal 33 are allocated to the right angle type connector, so that it is possible to use as standard products a plurality of types of right angle type connectors to which the first noise reduction part 40 is not yet attached, and the right angle type connector according to Embodiment 1 can reduce the man-hours and reduce the manufacturing cost.

Note that the first noise reduction part 40 is interposed at one of a portion between the part, near the bent portion 32c, of the first portion 32a of the second signal terminal 32 for differential signal and the part, near the bent portion 33c, of the first portion 33a of the grounding terminal 33, and a portion between the part, near the bent portion 32c, of the second portion 32b of the second signal terminal 32 for differential signal and the part, near the bent portion 33c, of the second portion 33b of the grounding terminal 33.

### Embodiment 2

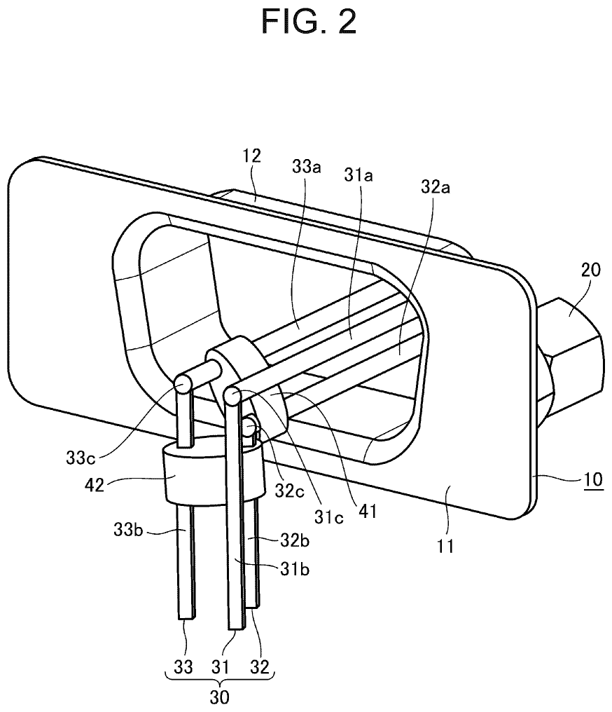

A right angle type connector according to Embodiment 2 will be described with reference to FIG. 2.

A difference is that, while the first noise reduction part 40 of the right angle type connector according to Embodiment 1 is interposed from the portion between the part, near the bent portion 32c, of the first portion 32a of the second signal terminal 32 for differential signal and the part, near the bent portion 33c, of the first portion 33a of the grounding terminal 33 to the portion between the part, near the bent portion 32c, of the second portion 32b of the second signal terminal 32 for differential signal and the part, near the bent portion 33c, of the second portion 33b of the grounding terminal 33, the right angle type connector according to Embodiment 2 includes a first noise reduction part 41 that is interposed between a part, near a bent portion 32c, of a first portion 32a of a second signal terminal 32 for differential signal and a part, near a bent portion 33c, of a first portion 33a of a grounding terminal 33, and a second noise reduction part 42 that is interposed between a part, near a bent portion 32c, of a second portion 32b of the second signal terminal 32 for differential signal and a part, near a bent portion 33c, of a second portion 33b of the grounding terminal 33, and the other points are the same.

Note that, in FIG. 2, the same reference numerals as those in FIG. 1 indicate identical or corresponding portions.

Next, the first noise reduction part 41 and the second noise reduction part 42 will be mainly described.

The first noise reduction part 41 is interposed between a part, near the bent portion 32c, of the first portion 32a of the second signal terminal 32 for differential signal and a part, near the bent portion 33c, of the first portion 33a of the grounding terminal 33, and increases a parasitic capacitance between the second signal terminal 32 for differential signal and the grounding terminal 33.

At a portion at which there is a difference between the lengths of the first portion 32a of the second signal terminal 32 for differential signal and a first portion 31a of a first signal terminal 31 for differential signal, the first noise reduction part 41 has one side portion that penetrates and is fixed to the first portion 32a located on the bent portion 32c side of the second signal terminal 32 for differential signal, and the other side portion that penetrates and is fixed to the first portion 33a located on the bent portion 33c side of the grounding terminal 33, and increases a parasitic capacitance between the first portion 32a located on the bent portion 32c side of the second signal terminal 32 for differential signal and the first portion 33a located on the bent portion 33c side of the grounding terminal 33.

The second noise reduction part 42 is interposed between a part, near the bent portion 32c, of the second portion 32b of the second signal terminal 32 for differential signal and a part, near the bent portion 33c, of the second portion 33b of the grounding terminal 33, and increases a parasitic capacitance between the second signal terminal 32 for differential signal and the grounding terminal 33.

At a portion at which there is a difference between the lengths of the second portion 32b of the second signal terminal 32 for differential signal and a second portion 31b of the first signal terminal 31 for differential signal, the second noise reduction part 42 has one side portion that penetrates and is fixed to the second portion 32b located on the bent portion 32c side of the second signal terminal 32 for differential signal, and the other side portion that penetrates and is fixed to the second portion 33b located on the bent portion 33c side of the grounding terminal 33, and increases a parasitic capacitance between the second portion 32b located on the bent portion 32c side of the second signal terminal 32 for differential signal and the second portion 33b located on the bent portion 33c side of the grounding terminal 33.

The first noise reduction part 41 and the second noise reduction part 42 function to make the parasitic capacitance between the second signal terminal 32 for differential signal and the grounding terminal 33 the same as the parasitic capacitance between the first signal terminal 31 for differential signal and the grounding terminal 33.

The first noise reduction part 41 and the second noise reduction part 42 function to make the parasitic capacitance between the second signal terminal 32 for differential signal and the grounding terminal 33 the same as the parasitic capacitance between the first signal terminal 31 for differential signal and the grounding terminal 33 particularly at a portion at which there is a difference between the lengths of the second signal terminal 32 for differential signal and the first signal terminal 31 for differential signal, so that deterioration of the degree of balance of the differential signals is suppressed.

As a result, it is possible to suppress an increase in radiated noise from the first signal terminal 31 for differential signal and the second signal terminal 32 for differential signal, and deterioration of noise immunity.

Each of the first noise reduction part 41 and the second noise reduction part 42 is made of, for example, a dielectric that has higher permittivity than that of the air.

Next, a specific configuration of each of the first noise reduction part 41 and the second noise reduction part 42 will be exemplified.

Each of the first noise reduction part 41 and the second noise reduction part 42 is a material of a sponge shape that penetrates the second signal terminal 32 for differential signal and the grounding terminal 33 on the both side portions, is fixed to the second signal terminal 32 for differential signal and the grounding terminal 33, and has higher permittivity than that of air.

Furthermore, each of the first noise reduction part 41 and the second noise reduction part 42 is a thermoplastic resin or a thermosetting resin that is fixed to the second signal terminal 32 for differential signal.

By using the thermoplastic resin or the thermosetting resin as each of the first noise reduction part 41 and the second noise reduction part 42, it is possible to make the thermoplastic resin or the thermosetting resin penetrate the second signal terminal 32 for differential signal and the grounding terminal 33 on the both side portions, and fix the thermoplastic resin or the thermosetting resin to the second signal terminal 32 for differential signal and the grounding terminal 33 after the first signal terminal 31 for differential signal, the second signal terminal 32 for differential signal, and the grounding terminal 33 are allocated in the right angle type connector.

In short, each of the first noise reduction part 41 and the second noise reduction part 42 is the material of the sponge shape, the thermoplastic resin, or the thermosetting resin, the first noise reduction part 41 and the second noise reduction part 42 can be attached to the right angle type connector according to Embodiment 2 after the right angle type connector to which the first noise reduction part 41 and the second noise reduction part 42 are not yet attached is finished and after the first signal terminal 31 for differential signal, the second signal terminal 32 for differential signal, and the grounding terminal 33 are allocated, and the first noise reduction part 41 and the second noise reduction part 42 can be mounted on a plurality of types of right angle type connectors using as standard products the right angle type connectors to which the first noise reduction part 41 and the second noise reduction part 42 are not yet attached, so that it is possible to reduce man-hours taken to finish the right angle type connector according to Embodiment 2, and reduce manufacturing cost.

As described above, the right angle type connector according to Embodiment 2 includes the first signal terminal 31 for differential signal, allocated for one signal of differential signals, the second signal terminal 32 for differential signal, allocated for the other signal of the differential signals, and the grounding terminal 33 allocated for grounding, and the first noise reduction part 41 is provided at the first portion 32a located on the bent portion 32c side of the second signal terminal 32 for differential signal whose entire length is shorter than the entire length of the first signal terminal 31 for differential signal, and the second noise reduction part 42 is provided at the second portion 32b, and the first noise reduction part 41 and the second noise reduction part 42 increase the parasitic capacitance between the second signal terminal 32 for differential signal and the grounding terminal 33, so that it is possible to suppress deterioration of the degree of balance of the differential signals flowing in the first signal terminal 31 for differential signal and the second signal terminal 32 for differential signal.

As a result, it is possible to suppress an increase in radiated noise from the first signal terminal 31 for differential signal and the second signal terminal 32 for differential signal, and deterioration of noise immunity.

Furthermore, the first noise reduction part 41 and the second noise reduction part 42 can be mounted after the first signal terminal 31 for differential signal, the second signal terminal 32 for differential signal, and the grounding terminal 33 are allocated to the right angle type connector, so that it is possible to use as standard products a plurality of types of right angle type connectors to which the first noise reduction part 41 and the second noise reduction part 42 are not yet attached, and the right angle type connector according to Embodiment 1 can reduce the man-hours and reduce the manufacturing cost.

### Embodiment 3

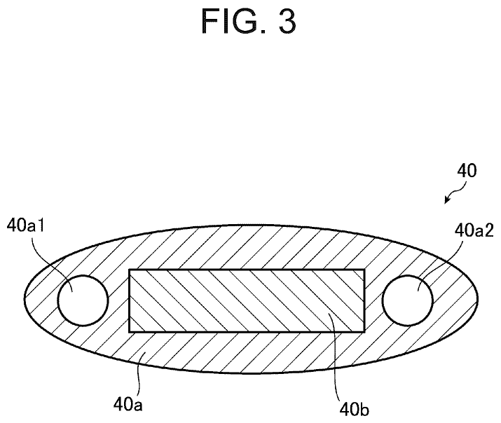

A right angle type connector according to Embodiment 3 will be described with reference to FIG. 3.

FIG. 3 is a cross-sectional view illustrating a noise reduction part 40 of the right angle type connector according to Embodiment 3.

The noise reduction part 40 of the right angle type connector according to Embodiment 3 illustrated in FIG. 3 is applicable to the first noise reduction part 40 of the right angle type connector according to Embodiment 1, and the first noise reduction part 41 and the second noise reduction part 42 of the right angle type connector according to Embodiment 2.

Hence, the noise reduction part 40 will be mainly described.

The noise reduction part 40 includes a non-conductive holding portion 40a that includes a first fixing portion 40al and a second fixing portion 40a2, and a noise reduction part 40b that is buried between the first fixing portion 40al and the second fixing portion 40a2 of the holding portion 40a and has higher permittivity than that of air.

The noise reduction part 40b is a dielectric that increases a parasitic capacitance between a second signal terminal 32 for differential signal and a grounding terminal 33 at a portion at which there is a difference between the lengths of the second signal terminal 32 for differential signal and a first signal terminal 31 for differential signal, that is, at at least one portion of a first portion and a second portion located on a bent portion 32c side.

The noise reduction part 40b has a rectangular planar shape as illustrated in FIG. 3, and has a shape in a length direction, expressed as a straight line extending along a first portion 32a or a second portion 32b of the second signal terminal 32 for differential signal or an L shape extending along the first portion 32a and the second portion 32b of the second signal terminal 32 for differential signal.

The holding portion 40a is formed of a material that has lower permittivity than permittivity of the noise reduction part 40b and has more flexibility than that of the noise reduction part 40b.

The holding portion 40a has the center portion at which the noise reduction part 40b is buried, and includes the first fixing portion 40al and the second fixing portion 40a2 on both sides of the noise reduction part 40b.

The holding portion 40a has an elliptical planar shape as illustrated in FIG. 3, and has a shape in a length direction, expressed as a straight line extending along the first portion 32a or the second portion 32b of the second signal terminal 32 for differential signal or an L shape extending along the first portion 32a and the second portion 32b of the second signal terminal 32 for differential signal.

The first fixing portion 40al of the holding portion 40a is a through-hole, the first fixing portion 40al penetrates the second signal terminal 32 for differential signal at a portion at which there is a difference between the lengths of the first portion 32a of the second signal terminal 32 for differential signal and a first portion 31a of the first signal terminal 31 for differential signal, and the holding portion 40a is fixed to the second signal terminal 32 for differential signal by, for example, an adhesive at the first fixing portion 40a1.

A position of the first fixing portion 40al of the holding portion 40a to be fixed to the second signal terminal 32 for differential signal is the first portion 32a located on the bent portion 32c side of the second signal terminal 32 for differential signal or the second portion 32b located on the bent portion 32c side, or the first portion 32a located on the bent portion 32c side and the second portion 32b located on the bent portion 32c side.

The second fixing portion 40a2 of the holding portion 40a is a through-hole, the second fixing portion 40a2 penetrates the grounding terminal 33 at a portion at which there is a difference between the lengths of the first portion 32a of the second signal terminal 32 for differential signal and the first portion 31a of the first signal terminal 31 for differential signal, and the holding portion 40a is fixed to the grounding terminal 33 by, for example, an adhesive at the second fixing portion 40a2.

A position of the second fixing portion 40a2 of the holding portion 40a to be fixed to the grounding terminal 33 is a first portion 33a located on a bent portion 33c side of the grounding terminal 33 or a second portion 33b located on the bent portion 33c side, or the first portion 33a located on the bent portion 33c side and the second portion 33b located on the bent portion 33c side.

According to the noise reduction part 40 of the right angle type connector according to Embodiment 3 configured as described above, the noise reduction part 40b that is buried in the holding portion 40a and has high permittivity can increase the parasitic capacitance between the second signal terminal 32 for differential signal and the grounding terminal at the portion at which there is the difference between the lengths of the first portion 32a of the second signal terminal 32 for differential signal and the first portion 31a of the first signal terminal 31 for differential signal, and so that it is possible to suppress deterioration of the degree of balance of the differential signals flowing in the first signal terminal 31 for differential signal and the second signal terminal 32 for differential signal.

Moreover, the noise reduction part 40 of the right angle type connector according to Embodiment 3 can be attached and fixed by the holding portion 40a that has flexibility to the second signal terminal 32 for differential signal and the grounding terminal 33 at the portion at which there is the difference between the lengths of the first portion 32a of the second signal terminal 32 for differential signal and the first portion 31a of the first signal terminal 31 for differential signal, so that the noise reduction part 40 has good workability and the noise reduction part 40 is easily attached to the second signal terminal 32 for differential signal and the grounding terminal 33.

Obviously, in a case where the noise reduction part 40 of the right angle type connector according to Embodiment 3 is applied to the first noise reduction part 40 of the right angle type connector according to Embodiment 1, and the first noise reduction part 41 and the second noise reduction part 42 of the right angle type connector according to Embodiment 2, the right angle type connector according to Embodiment 3 provides the same effect as those of the right angle type connectors according to Embodiment 1 and Embodiment 2.

Note that the embodiments can be freely combined, arbitrary components in the embodiments can be modified, or arbitrary components in the embodiments can be omitted.

### INDUSTRIAL APPLICABILITY

The right angle type connector according to the present disclosure is suitable for a right angle type connector that performs high speed transmission of differential signals between cables and a substrate housed inside a housing of an electronic device, and that electrically connects the cables and a wiring layer of the differential signals on the surface of the substrate housed inside the housing of the electronic device.

### REFERENCE SIGNS LIST

10: Metal shield, 11: Mounting plate, 12: Connector portion, 20: Connector Fixing screw, 30: Terminal, 31: First signal terminal for differential signal, 31a: First portion, 31b: Second portion, 31c: Bent portion, 32: Second signal terminal for differential signal, 32a: First portion, 32b: Second portion, 32c: Bent portion, 33: Grounding terminal, 33a: First portion, 33b: Second portion, 33c: Bent portion, 40 and 41: First noise reduction part, 42: Second noise reduction part, 40a: Holding portion, 40a1: First fixing portion, 40a2: Second fixing portion, 40b: Noise reduction part

1. A right angle type connector comprising:
a first signal terminal for differential signal, including a first portion and a second portion bent via a bent portion, and allocated for one signal of differential signals;
a second signal terminal for differential signal, including a first portion and a second portion bent via a bent portion, and allocated for an other signal of the differential signals, the second signal terminal for differential signal having a shorter entire length than an entire length of the first signal terminal for differential signal;
a grounding terminal including a first portion and a second portion bent via a bent portion, and allocated for grounding; and
a first noise reduction part to increase a parasitic capacitance between the second signal terminal for differential signal and the grounding terminal, the first noise reduction part being interposed between the first portion located on a bent portion side of the second signal terminal for differential signal and the first portion located on a bent portion side of the grounding terminal.

2. The right angle type connector according to claim 1, wherein
the first noise reduction part is continuously interposed between the second portion located on the bent portion side of the second signal terminal for differential signal and the second portion located on the bent portion side of the grounding terminal.

3. The right angle type connector according to claim 1, further comprising a second noise reduction part to increase the parasitic capacitance between the second signal terminal for differential signal and the grounding terminal, the second noise reduction part being interposed between the second portion located on the bent portion side of the second signal terminal for differential signal and the second portion located on the bent portion side of the grounding terminal.

4. The right angle type connector according to claim 1, wherein
the first signal terminal for differential signal has a distal end of the first portion that is connected to a corresponding lead by a connector portion, and a distal end of the second portion that penetrates a corresponding wiring layer formed in a substrate housed in an electronic device and is connected to the corresponding wiring layer,
the second signal terminal for differential signal has a distal end of the first portion that is connected to a corresponding lead by the connector portion, and a distal end of the second portion that penetrates a corresponding wiring layer formed in the substrate housed in the electronic device and is connected to the corresponding wiring layer, and
the grounding terminal has a distal end of the first portion that is connected to a corresponding lead by the connector portion, and a distal end of the second portion that penetrates a corresponding wiring layer formed in the substrate housed in the electronic device and is connected to the corresponding wiring layer.

5. The right angle type connector according to claim 1, wherein
the first signal terminal for differential signal has a distal end of the first portion that penetrates a corresponding wiring layer formed in a substrate housed in an electronic device and that is connected to the corresponding wiring layer, and a distal end of the second portion that is connected to a corresponding lead by a connector portion,
the second signal terminal for differential signal has a distal end of the first portion that penetrates a corresponding wiring layer formed in the substrate housed in the electronic device and is connected to the corresponding wiring layer, and a distal end of the second portion that is connected to a corresponding lead by the connector portion, and
the grounding terminal has a distal end of the first portion that penetrates a corresponding wiring layer formed in the substrate housed in the electronic device and is connected to the corresponding wiring layer, and a distal end of the second portion that is connected to a corresponding lead by the connector portion.

6. A right angle type connector comprising:
a first signal terminal for differential signal, including a first portion and a second portion bent via a bent portion, and allocated for one signal of differential signals;
a second signal terminal for differential signal, including a first portion and a second portion bent via a bent portion, and allocated for an other signal of the differential signals, the second signal terminal for differential signal having a shorter entire length than an entire length of the first signal terminal for differential signal;
a grounding terminal including a first portion and a second portion bent via a bent portion, and allocated for grounding; and
a first noise reduction part interposed between the first portion located on a bent portion side of the second signal terminal for differential signal and the first portion located on a bent portion side of the grounding terminal, and having higher permittivity than permittivity of air.

7. The right angle type connector according to claim 6, wherein
the first noise reduction part is made of a material of a sponge shape that penetrates the second signal terminal for differential signal and is fixed to the second signal terminal for differential signal.

8. The right angle type connector according to claim 6, wherein
the first noise reduction part is made of a thermoplastic resin or a thermosetting resin that is fixed to the second signal terminal for differential signal.

9. The right angle type connector according to claim 6, wherein
the first noise reduction part is fixed to the second signal terminal for differential signal by a noise-reduction-part holding member.

10. The right angle type connector according to claim 6, wherein
the first noise reduction part includes a non-conductive holding portion including a first fixing portion penetrating and fixed to the second signal terminal for differential signal, and a second fixing portion penetrating and fixed to the grounding terminal, and a noise reduction part buried between the first fixing portion and the second fixing portion of the holding portion and having higher permittivity than the permittivity of the air.

11. The right angle type connector according to claim 6, wherein
the first noise reduction part is continuously interposed between the second portion located on the bent portion side of the second signal terminal for differential signal and the second portion located on the bent portion side of the grounding terminal.

12. The right angle type connector according to claim 6, further comprising a second noise reduction part interposed between the second portion located on the bent portion side of the second signal terminal for differential signal and the second portion located on the bent portion side of the grounding terminal, and having higher permittivity than permittivity of air.

13. The right angle type connector according to claim 6, wherein
the first signal terminal for differential signal has a distal end of the first portion that is connected to a corresponding lead by a connector portion, and a distal end of the second portion that penetrates a corresponding wiring layer formed in a substrate housed in an electronic device and is connected to the corresponding wiring layer,
the second signal terminal for differential signal has a distal end of the first portion that is connected to a corresponding lead by the connector portion, and a distal end of the second portion that penetrates a corresponding wiring layer formed in the substrate housed in the electronic device and is connected to the corresponding wiring layer, and
the grounding terminal has a distal end of the first portion that is connected to a corresponding lead by the connector portion, and a distal end of the second portion that penetrates a corresponding wiring layer formed in the substrate housed in the electronic device and is connected to the corresponding wiring layer.

14. The right angle type connector according to claim 6, wherein
the first signal terminal for differential signal has a distal end of the first portion that penetrates a corresponding wiring layer formed in a substrate housed in an electronic device and is connected to the corresponding wiring layer, and a distal end of the second portion that is connected to a corresponding lead by a connector portion,
the second signal terminal for differential signal has a distal end of the first portion that penetrates a corresponding wiring layer formed in the substrate housed in the electronic device and is connected to the corresponding wiring layer, and a distal end of the second portion that is connected to a corresponding lead by the connector portion, and
the grounding terminal has a distal end of the first portion that penetrates a corresponding wiring layer formed in the substrate housed in the electronic device and is connected to the corresponding wiring layer, and a distal end of the second portion that is connected to a corresponding lead by the connector portion.

15. A noise reduction part that is attached to a right angle type connector that comprises: a first signal terminal for differential signal, including a first portion and a second portion bent via a bent portion, and allocated for one signal of differential signals; a second signal terminal for differential signal, including a first portion and a second portion bent via a bent portion, and allocated for an other signal of the differential signals, the second signal terminal for differential signal having a shorter entire length than an entire length of the first signal terminal for differential signal; a grounding terminal including a first portion and a second portion bent via a bent portion, and allocated for grounding, the noise reduction part comprising:
a non-conductive holding portion including a first fixing portion penetrating and fixed to the second signal terminal for differential signal, and a second fixing portion penetrating and fixed to the grounding terminal; and
a noise reduction part buried between the first fixing portion and the second fixing portion of the holding portion and having higher permittivity than permittivity of air.

16. The noise reduction part according to claim 15, wherein
the holding portion is made of a material having lower permittivity than the permittivity of the noise reduction part and having more flexibility than flexibility of the noise reduction part.
